(19) United States
(12) Patent Application Publication
(10) Pub. No.: US 2005/0121219 A1
(43) Pub. Date: Jun. 9, 2005

(54) Bushing with integrated rotation angle transmitter

(76) Inventor: Heiko Pohl, Seevetal (DE)

Correspondence Address: HARNESS, DICKEY & PIERCE, P.L.C., P.O. BOX 828, BLOOMFIELD HILLS, MI, 48303, US

(21) Appl. No.: 10/944,694

(22) Filed: Sep. 17, 2004

(30) Foreign Application Priority Data
Sep. 18, 2003 (DE) 10343588.3

(51) Int. Cl. H02G 3/18

(52) U.S. Cl. 174/65 G

(57) ABSTRACT

The invention relates to a bushing, particularly a moving gear bushing, consisting of at least a metallic or plastic core, and an elastomer body disposed around the core and connected with the core in an adhering manner. The bushing of the invention is characterized in that detectable material particles are embedded in the elastomer body or in an additional polymer matrix, particularly an elastomer matrix. The particles serve as a rotation angle transmitter and in turn cooperate with a rotation angle detector, with the aid of which angle changes within the bushing can be detected and in the form of a signal made available for headlight leveling control. In particular, the detectable material particles used form a strongly adhering bond with the core, and on the core create magnetic fields with alternating poles (N, S). The angle changes within the bushing are detected through the number of poles. The material particles are preferably rod magnets or magnetized ferrite particles.

### FIELD OF THE INVENTION

The invention relates to a bushing, particularly a moving gear bushing, consisting of at least a metallic or plastic core, and an elastomer body disposed around the core and connected with the core in an adhering manner.

### BACKGROUND OF THE INVENTION

Bushings are widely used in automotive manufacturing so that only the following prior art will be discussed in some detail.

Moving gear bushings are used to interconnect component parts, to transmit forces and torques, to permit displacements and torsion, and to dampen noise and vibrations. In this respect, the reader is referred to German Unexamined Patent Application DE 199 31 079 A1.

It is also known from German Unexamined Patent Application DE 197 52 635 A1 to combine bearing bushings, the elastomer body of which is provided with a pair of hollow spaces, with a system of electromagnets and a control unit. In this case, the currents supplied by the control unit to the electromagnet are optional such that the elastomer body within the holder is turned to a predetermined angle. As a result of the differently turned hollow spaces in the elastomer body, different elastic forces act in the direction of the force.

As will be explained below, bushings, particularly moving gear bushings, are subject to novel requirements which need to be met.

Modern automobiles must increasingly be equipped with a headlight leveling control to regulate the illumination as a function of the load. For this purpose, rotation angle transmitters are mounted on the suspension arms of the rear axle. The mounting of these separate rotation angle transmitters, however, is quite costly and, in addition, they require mounting space on the rear axle of the automobile.

The object of the invention, therefore, is to provide a bushing, particularly a moving gear bushing, which for purposes of a headlight leveling control is configured so that a separate rotation angle transmitter can be omitted to facilitate mounting and to reduce the required mounting space. The concept is applicable to a multiplicity of bushing constructions within the basic design of this kind.

### SUMMARY OF THE INVENTION

The above objective is reached by embedding into the elastomer body, or into an additional polymer matrix, detectable material particles that serve as a rotation angle transmitter which cooperate with a rotation angle detector whereby the angle changes within the bushing are made available as a signal for headlight leveling control.

A particularly advantageous embodiment of the invention lies in that the detectable material particles are connected with the core in a tightly adhering manner and form magnetic fields on the core. The angle changes within the bushing are detected through a number of the poles. The material particles are preferably rod magnets or magnetized ferrite particles.

### BRIEF DESCRIPTION OF THE DRAWINGS

The invention will now be explained with the aid of practical examples and with reference to schematic drawings, in which:

FIG. 1 shows a conventional bushing;

FIG. 2 shows a bushing with nodules according to a principle of the present invention;

FIG. 3 shows a bushing with a contoured core according to a principle of the present invention;

FIG. 4 shows a slotted bushing according to a principle of the present invention;

FIG. 5 shows a bushing without a sleeve according to a principle of the present invention;

FIG. 6 shows a bushing with intermediate sheet metal according to a principle of the present invention;

FIG. 7 shows a collar bushing according to a principle of the present invention;

FIG. 8 shows a bushing core comprising magnetic fields with alternating poles according to a principle of the present invention; and

FIG. 9 shows a bushing arrangement of a moving gear according to a principle of the present invention.

### DETAILED DESCRIPTION OF THE PREFERRED EMBODIMENTS

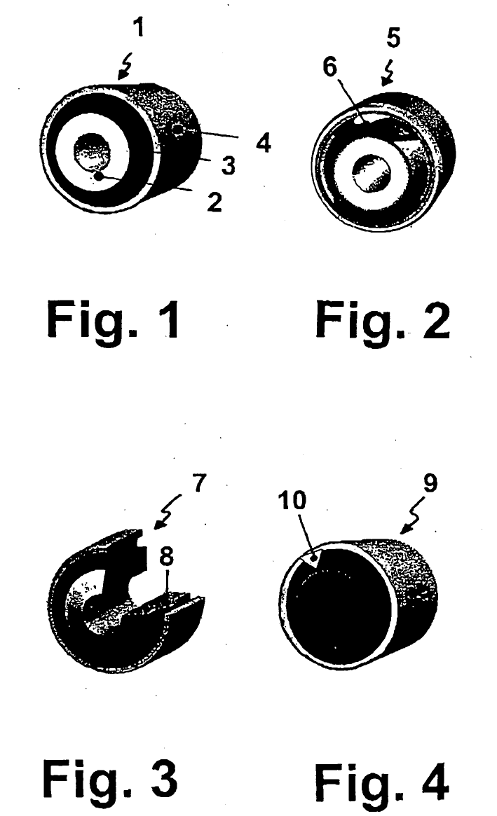

The bushings according to FIGS. 1 to 7 are conventional moving gear bushings to be equipped with an integrated rotation angle transmitter.

FIG. 1 shows a conventional bushing 1 consisting of a cylindrical core 2 of tubular shape, a sleeve 3, and an elastomer body 4 disposed between the core 2 and the sleeve 3. The core 2 and the sleeve 3 in most cases are made of metal, particularly steel or aluminum. Appropriate plastic materials (for example based on a polyphenylene ether, Vestoran®, supplied by Huls) are also used. The elastomer body 4 is in most cases a vulcanized rubber blend based on natural rubber or a synthetic rubber, for example silicone-rubber (DE 44 22 048 A1). The adhesion of the elastomer body 4 to the core 2 and the sleeve 3 is preferably achieved by vulcanization.

FIGS. 2 to 4 show the same core-sleeve concept for a bushing 5 with modules 6 (FIG. 2), a bushing 7 with a bulging core contour 8 (FIG. 3) and a bushing 9 with a slot 10 (FIG. 4).

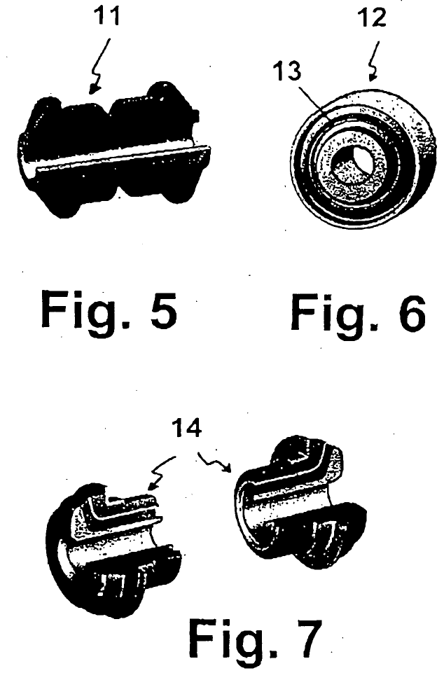

In addition to the conventional bushings according to FIGS. 1 to 4, a bushing 11 without a sleeve (FIG. 5), a bushing (12) with at least one intermediate sheet metal layer in the form of a multileaf spring design (FIG. 6) and collar bushings (14) (FIG. 7) are contemplated. Moreover, there are bushings with a sliding layer between the core 2 and/or the sleeve 3 and the elastomer body 4.

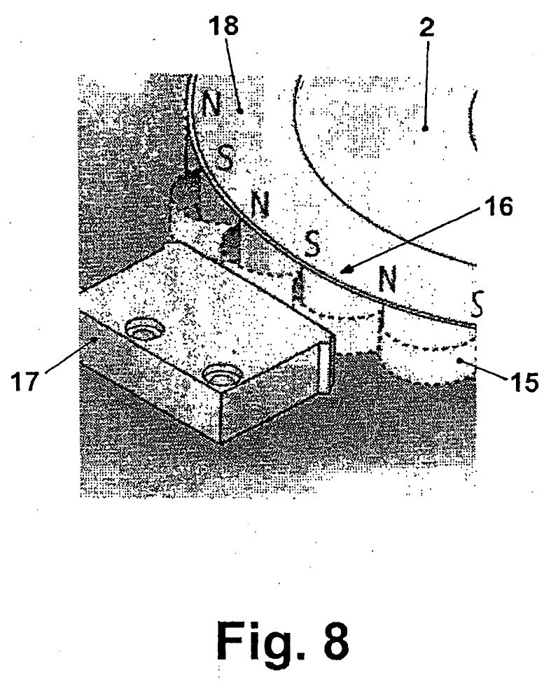

FIG. 8 shows a core 2 of a bushing that is provided with an integrated rotation angle transmitter 16. The detectable material particles are ferrite particles, preferably embedded in an elastomer matrix 18. The matrix is vulcanized onto the core 2, giving rise to a strongly adhering bond. The system is then magnetized so that magnetic fields 15 with alternating poles (N, S) are created on the core 2. The magnetic fields serve as rotation angle transmitters 16. Changes in the angle between the core 2 and the sleeve 3 are detected by a rotation angle detector 17 through the number of poles and, in the form of a signal, are made available for headlight leveling control.

This modified core 2 with an integrated rotation angle transmitter 16 is in turn bonded to the elastomer body in a strongly adhering manner, usually by vulcanization of the rubber blend involved.

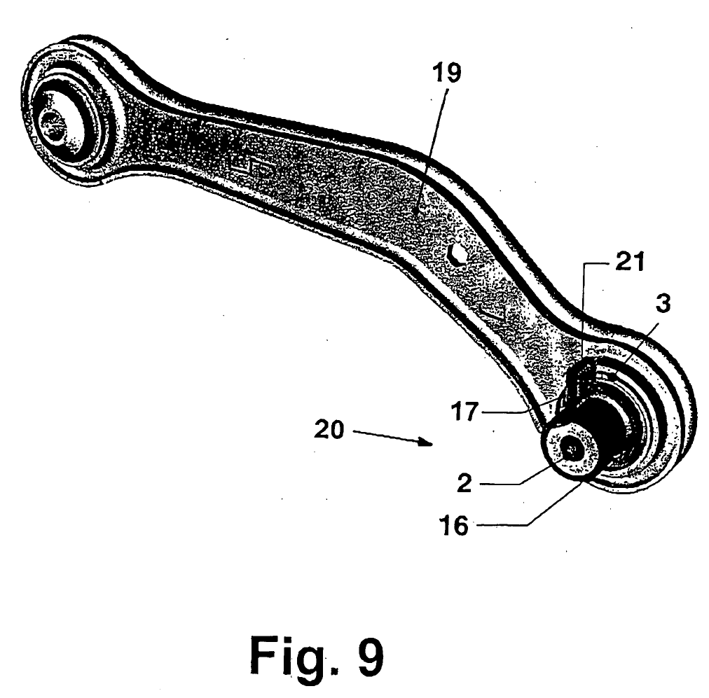

FIG. 9 shows a moving gear part with a brace 19 and two bushing seats each of which contain a bushing. Moving gear bushing 20 comprises a core 2, a sleeve 3, a rotation angle transmitter 16, as well as a rotation angle detector 17 connected with the sleeve 3 and provided with a signal cable 21 for headlight leveling control.

As a result of the preferred embedding of the detectable material particles into an additional matrix, also referred to as a coded matrix, the previously used elastomer materials, a wide range of which are available, can continue to be used for the elastomer body 4. In addition, the fabrication of such a bushing with an integrated rotation angle transmitter 16 is simple and inexpensive.

When the detectable particles are embedded into the elastomer body 4, care must be taken that the functioning of the bushing, for example when used for noise and vibration damping, is not deleteriously affected. Here, too, the detectable particles are preferably embedded into a an additional polymer matrix, particularly an elastomer matrix. This coded matrix is then integrated into the elastomer body 4.

The integrated rotation angle transmitter 16 can extend over the entire length of the bushing or, preferably, be present only in the region of the bushing where the rotation angle detector 17 is essentially operative, as can be seen from FIGS. 8 and 9.

The entire disclosure of German Patent Application 103 43 588.3, filed 18 September, 2003, is hereby incorporated by reference.

1. A bushing comprising:
a metallic or plastic core; and
an elastomer body disposed around the core and connected with the core in an adhering manner;
wherein detectable material particles are embedded in the elastomer body or in polymer matrix, the particles serving as a rotation angle transmitter which cooperates with a rotation angle detector to detect angle changes within the bushing in the form of a signal made to be used for headlight leveling control.

2. The bushing according to claim 1, wherein the detectable particles form a tight adhesion bond with the core.

3. The bushing according to claim 2, wherein the adhesion bond between the detectable material particles and the core is obtained by vulcanization.

4. The bushing according to claims 1, wherein the detectable material particles form magnetic fields with alternating poles (N, S), the angle changes within the bushing being detected through the number of poles.

5. The bushing according to claim 4, wherein the detectable particles form magnetic fields with alternating poles (N, S) on the core.

6. The bushing according to claim 4, wherein the detectable material particles are rod magnets.

7. The bushing according to claim 4, wherein the detectable material particles are magnetized ferrite particles.

8. The bushing according to claim 7, wherein the magnetization of the ferrite particles is carried out after the vulcanization.

9. The bushing according to claims 1, further comprising a sleeve made of metal or a plastic material, said sleeve surrounding the elastomer body in an adhering manner.

10. The bushing according to claim 9, wherein the rotation angle detector is connected with the sleeve.

11. The bushing according to claims 9, wherein the rotation angle transmitter extends over an entire longitudinal direction of the sleeve or is present only in a region of the bushing where the rotation angle detector is operative.
